(19) United States
(12) Patent Application Publication
(10) Pub. No.: US 2024/0127984 A1
(43) Pub. Date: Apr. 18, 2024

(54) Extruder for extruding an electrically insulating layer comprising a barrel having a liquid injection channel

(71) Applicant: NEXANS, Courbevoie (FR)

(72) Inventors: Tarik SADIK, Chasse-sur-Rhône (FR); Stephan PUISSANT, Lyon (FR); Gabriele PEREGO, MILAN (IT)

(21) Appl. No.: 18/231,231

(22) Filed: Aug. 7, 2023

(30) Foreign Application Priority Data
Aug. 8, 2022 (FR) 2208178

(51) Int. Cl. H01B 13/14

(52) U.S. Cl. CPC H01B 13/147; H01B 13/148

(57) ABSTRACT

An extruder (5) for extruding an electric cable has an extrusion screw (7) arranged inside a barrel (6) and making it possible for the polymer to melt gradually in order to form an extrusion composition and for this composition to be transported along the extrusion screw (7). An extrusion head (8) is arranged at a distal end (21) of the extrusion screw (7) and configured to apply the composition around an elongated electrically conductive element. The at least one liquid injection channel (22) is formed through the barrel (6), the at least one injection channel (22) having at least one outlet orifice (30) emerging in a zone of the extrusion screw (7) in which the thermoplastic polymer is at least partially in the solid state.

### RELATED APPLICATION

This application claims the benefit of priority from French Patent Application No. 22 08178, filed on Aug. 8, 2022, the entirety of which is incorporated by reference.

### TECHNICAL FIELD

The present invention relates to an extruder for extruding an electric cable, in particular of the power cable type, comprising a thermoplastic layer extruded around at least one elongated electrically conductive element. The invention also proposes a method for manufacturing an electric cable with such an extruder.

It typically, but not exclusively, applies to electric cables intended for power transmission, in particular medium-voltage power cables (in particular from 6 to 45-60 kV) or high-voltage power cables (in particular greater than 60 kV, and which can be up to 400 kV), whether they are for direct current or alternating current, in the fields of overhead, undersea or underground electricity transmission, or alternatively in the field of aeronautics.

A medium- or high-voltage power transmission cable generally comprises, from the inside to the outside:
an elongated electrically conductive element, in particular made from copper or aluminium;
an inner semiconductive layer surrounding said elongated electrically conductive element;
an electrically insulating layer surrounding said inner semiconductive layer;
an outer semiconductive layer surrounding said insulating layer; and
optionally, an electrically insulating protective sheath surrounding said outer semiconductive layer.

### TECHNOLOGICAL BACKGROUND

The extruded composition forming the electrically insulating layer can require the addition of a liquid to the thermoplastic polymer. It is known practice to inject this liquid before inserting the thermoplastic polymer into the barrel, for example into a hopper communicating with the barrel. The liquid is thus mixed with the thermoplastic polymer before or at the time when it is inserted into the barrel. It has however been observed that this method for injecting the liquid could result in manufacturing defects in the electrically insulating layer, linked in particular to a slippage or sliding phenomenon. This sliding phenomenon at the wall linked to the lubricating effect of the dielectric liquid can result in the deterioration of the mechanical and/or electrical properties of the thermoplastic layer obtained at the extrusion head (structural defects in the layer), in particular the variation of the diameter of the cable.

In addition, injecting liquid into the hopper can cause liquid to leak through the proximal end of the extrusion screw, opposite the extrusion head.

It has also been observed that mixing the liquid with the thermoplastic polymer in solid form is not optimal when the liquid is injected into the hopper.

One solution known from WO 02/47092 A1 consists of providing holes formed through the barrel of the extruder in order to inject a liquid between the extrusion screw and the barrel, in contact with the thermoplastic polymer in the molten state. Such a solution has the drawback that it is difficult to implement as the composition is subject to high pressure in this part of the extrusion screw.

There is therefore a need for an extruder configuration that makes it possible to promote the mixing of the liquid with the thermoplastic polymer while avoiding the risk of the liquid leaking at the rear of the extruder and while limiting the deterioration of the mechanical and/or electrical properties of the thermoplastic layer.

### SUMMARY OF THE INVENTION

To this end, the invention proposes an extruder for extruding an electric cable comprising at least one elongated electrically conductive element and at least one extruded thermoplastic layer surrounding said elongated electrically conductive element, said extruder comprising:
a member for feeding a polymer in solid form,
a barrel fed by the feed member,
an extrusion screw arranged inside the barrel and making it possible for the polymer to melt gradually to form an extrusion composition and for this composition to be transported along the extrusion screw to a distal end of the extrusion screw, said extrusion screw extending along a longitudinal axis, said extrusion screw comprising a barrier zone having at least two threads,
an extrusion head arranged at a distal end of the extrusion screw and configured to apply the composition around an elongated electrically conductive element,
   wherein at least one channel for injecting a liquid is formed through the barrel, said at least one injection channel comprising at least one outlet orifice emerging in a zone of the extrusion screw in which the thermoplastic polymer is at least partially in the solid state.

The composition is subject to significantly lower pressure in the feed zone than near the distal end of the extrusion screw, near the extrusion head. Injecting the liquid in the feed zone, in which the thermoplastic polymer is still at least partially solid, makes it possible to limit the constraints to be taken into account for the injection of the liquid. It is thus easier to inject the liquid in this part of the extruder.

As injection takes place through the barrel and not by means of the hopper or feed member, the sliding phenomenon and the risks of leaks are limited or even eliminated.

According to one embodiment of the extruder, the distance separating said at least one outlet orifice from the feed member, projected on the longitudinal axis, is less than or equal to 8D, D being the nominal diameter of the extrusion screw.

According to one embodiment of the extruder, the distance separating said at least one outlet orifice from the feed member, projected on the longitudinal axis, is greater than or equal to 2D, D being the nominal diameter of the extrusion screw.

According to one embodiment of the extruder, said at least one injection channel comprises at least one inlet orifice formed on an outer surface of the barrel, said at least one outlet orifice emerging on an inner surface of the barrel, said at least one injection channel extending through the barrel between said at least one inlet orifice and said at least one outlet orifice.

According to one embodiment of the extruder, said at least one injection channel extends perpendicular to the longitudinal axis.

According to one embodiment of the extruder, it comprises a plurality of injection channels formed through the barrel and distributed about the longitudinal axis.

According to one embodiment of the extruder, the injection channels are positioned in the same plane perpendicular to the longitudinal axis.

According to one embodiment of the extruder, it further comprises a liquid feed member communicating with said at least one injection channel.

According to one embodiment of the extruder, said at least one outlet orifice is formed so that the distance separating said at least one outlet orifice from the feed member, projected on the longitudinal axis, is greater than or equal to 3D, D being the nominal diameter of the extrusion screw. At this distance of 3D, the polymer is generally in the completely solid state.

According to one embodiment of the extruder, said at least one outlet orifice is formed so that the distance separating said at least one outlet orifice from the feed member, projected on the longitudinal axis, is greater than or equal to 4D. At this distance of 4D, the polymer is in the partially molten and partially solid state.

According to one embodiment of the extruder, said at least one outlet orifice emerges upstream of the barrier zone, between the feed member and the barrier zone. This makes it possible to inject the liquid in a zone in which the pressure inside the barrel is lower compared to other zones of the barrel.

According to one embodiment of the extruder, the barrier zone of the extrusion screw starts at a distance separating the barrier zone from the feed member, projected on the longitudinal axis, greater than or equal to 8D.

According to one embodiment of the extruder, the distance separating the barrier zone from the feed member, projected on the longitudinal axis, is defined as being between 8D and 12D.

According to one embodiment of the extruder, the outlet orifice is arranged in a zone starting at a distance greater than or equal to 4D and ending at a distance less than or equal to 8D or 12D. These distances are taken with reference to the feed member, along the longitudinal axis A.

The invention further proposes a method for manufacturing an electric cable comprising at least one elongated electrically conductive element and at least one extruded thermoplastic layer surrounding said elongated electrically conductive element, said method implementing an extruder as described above, characterized in that it comprises at least the following steps:
i) a step of introducing a composition comprising at least one thermoplastic polymer in solid form into a zone of the extrusion screw referred to as the feed zone and situated at the inlet of the extruder,
ii) a step during which the composition resulting from step i) is conveyed from the feed zone to one or more intermediate zones of the extrusion screw, making it possible for the composition to be transported to the extrusion head situated at the outlet of the extruder and for the thermoplastic polymer to melt gradually,
iii) a step of applying the composition resulting from step ii) around the elongated electrically conductive element at the head of the extruder,
wherein at least one liquid is injected, in the feed zone, between the barrel and the extrusion screw through said at least one injection channel formed in the barrel.

According to one embodiment of the method, said at least one thermoplastic polymer in solid form is selected from a propylene homopolymer and a propylene copolymer, the liquid being a dielectric liquid.

### BRIEF DESCRIPTION OF THE FIGURES

The following description provided with reference to the appended drawings, which are given by way of non-limiting example, will make it easy to understand what the invention consists of and how it can be implemented. In the appended figures:

FIG. 1 schematically shows a partial cross-section of an extruder comprising in particular an extrusion screw and a barrel.

FIG. 2 schematically shows a partial perspective cross-section of an electric cable obtained with the extruder in FIG. 1.

FIG. 3 schematically shows a partial cross-section of an extruder according to the invention wherein an outlet orifice for a liquid is formed through the barrel in order to inject a liquid between the barrel and the extrusion screw in a feed zone of the extrusion screw.

FIG. 4 is a front view of the extruder in FIG. 3, highlighting a plurality of injection orifices.

### DESCRIPTION OF EMBODIMENT(S)

For reasons of clarity, only the elements essential for understanding the invention have been shown schematically in these figures, which are not to scale.

The concept of the invention is described more fully below with reference to the appended drawings, which show embodiments of the concept of the invention. In the drawings, the size and the relative sizes of the elements can be exaggerated for the sake of clarity. Similar numbers refer to similar elements throughout the drawings. However, this concept of the invention can be implemented in many different forms and should not be interpreted as being limited to the embodiments set out here. Instead, these embodiments are provided so that this description is comprehensive, and communicate the scope of the concept of the invention to those skilled in the art.

Reference throughout the specification to “an/one embodiment” means that a particular function, structure or feature described in relation to one embodiment is included in at least one embodiment of the present invention. The occurrence of the expression “in one embodiment” in various places throughout the specification does not thus necessarily refer to the same embodiment. Furthermore, the particular functions, structures or features can be combined in any suitable manner in one or more embodiments. In addition, the term “comprising” does not rule out other elements or steps.

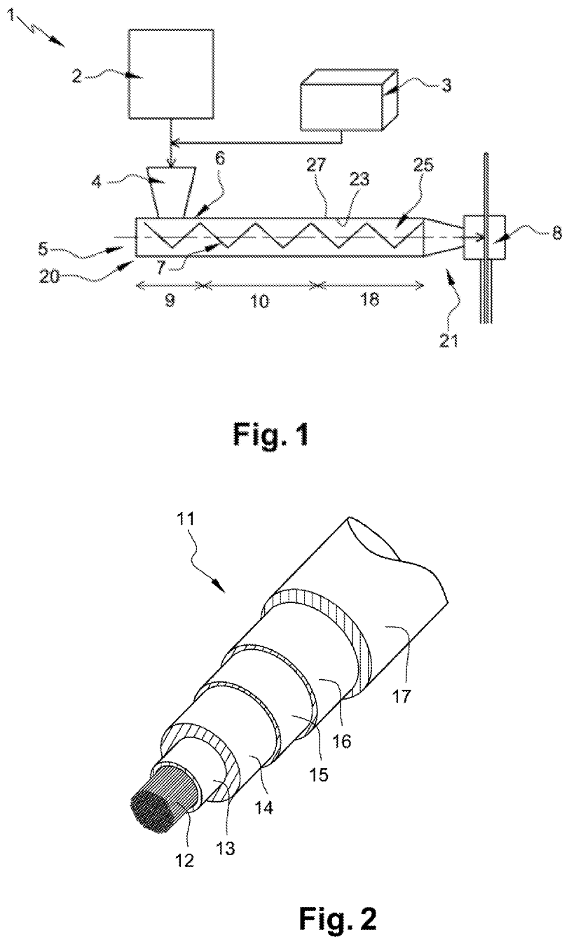

In FIG. 1, the device 1 comprises a container 2 that can be fed with granules of a thermoplastic polymer, a feed hopper 4 that can be fed at ambient temperature with the granules of the thermoplastic polymer contained in the container 2 and an extruder 5 comprising for example a barrel 6, an extrusion screw 7 and an extrusion head 8.

The barrel 6 forms an inner cavity in which the extrusion screw 7 is arranged. The barrel 6 is fed with a thermoplastic polymer by a feed member, here the feed hopper 4.

The thermoplastic polymer in solid form can be a crosslinked polyolefin such as a crosslinked polyethylene (XLPE), or a crosslinked ethylene-propylene or ethylene-propylene-diene elastomer. According to one particular preferred application, the thermoplastic polymer comprises a propylene-based thermoplastic such as a propylene homopolymer or a propylene copolymer.

The extrusion screw 7 extends along a longitudinal axis A. The extrusion screw 7 is configured to be rotated about the longitudinal axis A. The extrusion screw 7 comprises at least one thread extending around and along said elongated body 24.

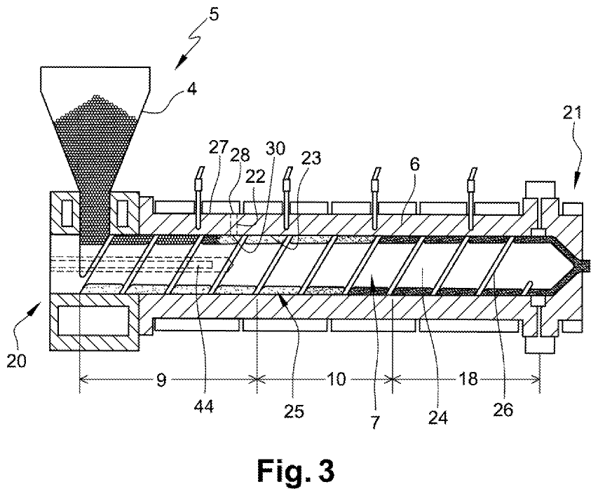

The extrusion screw 7 comprises an elongated body 24 and at least one thread 26 (see FIG. 3). The extrusion screw 7 makes it possible to increase the pressure of the thermoplastic polymer, transport the thermoplastic polymer and, optionally, mix the thermoplastic polymer up to the extrusion head 8, where the composition formed by the molten thermoplastic polymer is applied around an elongated electrically conductive element.

The extruder 5 can be a single-screw extruder as illustrated in FIG. 1 or a twin-screw extruder. The extruder 5 thus comprises at least one extrusion screw 7.

The extrusion screw 7 is preferably a barrier screw or a screw having a barrier profile, i.e. a screw comprising a zone referred to as the “barrier zone”. This barrier zone particularly comprises a secondary thread with a slightly greater pitch (progressively sweeping the width of the channel) which makes it possible to separate the molten polymer from the polymer that is still solid, as if it marked the boundary between the two phases. It thus makes it possible to compress the solid bed and as a result improve the melting capacity of the screw.

These barrier screws comprise a feed zone 9 situated at a proximal end 20 of the extrusion screw 7 intended to be arranged level with the feed to the extrusion screw 7, e.g. level with the feed hopper 4. The thermoplastic polymer is in the solid state in this feed zone 9 when the extruder 5 is operating. The extrusion screw 7 also comprises a distal end 21 arranged opposite the proximal end 20.

This feed zone 9 is followed by a barrier or intermediate zone 10 making it possible for the polymer to melt gradually and be transported to the outlet of the extruder provided by an end zone of the screw referred to as the pumping zone 18.

The barrier zone 10 thus comprises a main thread and a secondary thread extending around the elongated body 24 of the extrusion screw 7 along the longitudinal axis A. The secondary thread has a greater pitch than the main thread so that the distance separating the main and secondary threads varies along the longitudinal axis A.

The barrier zone 10 of the extrusion screw 7 is arranged at a distance of between 8D and 12D from the feed member 4, along the longitudinal axis A. This barrier zone extends over a distance of between 4D and 6D.

The barrier or intermediate zone 10 extends to the pumping zone 18 of the extrusion screw 7.

The pumping zone 18 can have a length up to two times the diameter of the extrusion screw. The composition leaving the barrier or intermediate zone 10, after passing into the pumping zone 18, is directly transported into the head 8 of the extruder in order to be applied around the elongated electrically conductive element.

A specific barrel 6 (i.e. a grooved barrel) can be used. This makes it possible, particularly combined with a barrier screw, to obtain a homogeneous composition that is easy to extrude, while preventing or limiting the formation of structural defects in the thermoplastic layer obtained, in particular of the electrically insulating layer type.

In FIG. 2, the medium- or high-voltage power cable 11 obtained according to the method of the invention comprises a central elongated electrically conductive element 12, in particular made from copper or aluminium, and successively and coaxially comprises, around this element 12, a first semiconductive layer 13 known as the “inner semiconductive layer”, an electrically insulating layer 14, a second semiconductive layer 15 known as the “outer semiconductive layer”, a metal shield 16 of the cylindrical tube type and an exterior protective sheath 17.

The layers 13 and 15 are layers extruded by methods well known to a person skilled in the art.

The presence of the metal shield 16 and of the exterior protective sheath 17 is preferable but not essential.

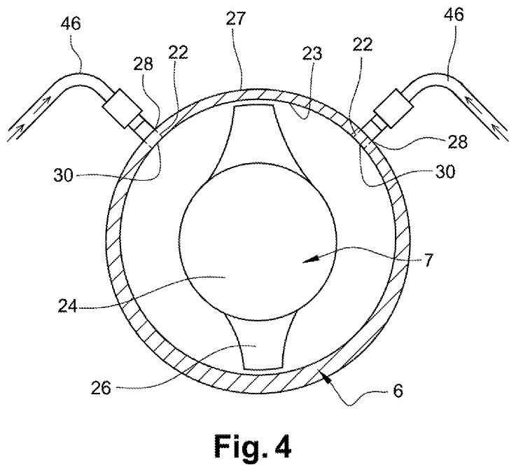

With reference to FIGS. 3 and 4, a liquid injection channel 22 is formed through the barrel 6 in order to inject a liquid between the barrel 6 and the extrusion screw 7. The injection channel 22 is particularly formed on an inner surface 23 of the barrel 6 facing the extrusion screw 7. The inner surface 23 of the barrel forms a cavity 25 in which the extrusion screw is arranged. A plurality of injection channels 22 can be formed through the barrel 6.

The liquid can be a dielectric liquid.

The extruder 5 can comprise a liquid feed member (not shown) communicating with the injection channel 22.

The injection channel 22 is preferably arranged on an upper portion of the barrel 6.

The injection channel 22 extends inside the barrel 6 between an inlet orifice 28 and an outlet orifice 30.

The inlet orifice 28 makes it possible to feed the injection channel 22 with liquid. The inlet orifice 28 is formed on an outer surface 27 of the barrel 6. A device for connection to the liquid feed member can be secured to the inlet orifice 28.

A plurality of inlet orifices 28 can be provided, for example for injecting a liquid from a plurality of separate sources or in order to inject different liquids. It is also possible to provide a plurality of injection channels 22 so that the barrel 6 comprises a plurality of inlet orifices 28.

The outlet orifice 30 emerges inside the barrel 6 so that it injects the liquid between the barrel 6 and the extrusion screw 7. The outlet orifice 30 particularly emerges on the inner surface 23 of the barrel 6 facing the extrusion screw 7.

The outlet orifice 30 can be formed at a predetermined distance from the feed member or feed hopper 4, in particular along the longitudinal axis A. The injection channel 22 can thus be formed so that the distance separating the outlet orifice 30 from the feed member 4, projected on the longitudinal axis A, is greater than or equal to 3D, preferably greater than or equal to 4D. D is the nominal diameter of the extrusion screw. This positioning of the outlet orifice 30 makes it possible to inject the liquid at a sufficient distance to limit, or even avoid, the sliding phenomenon.

The injection channel 22 can also be formed so that the distance separating the outlet orifice 30 from the feed member 4, projected on the longitudinal axis A, is less than or equal to 8D, preferably less than or equal to 7D, more preferably less than or equal to 6D. The outlet orifice 30 is thus facing a zone of the extrusion screw 7 in which the thermoplastic polymer is at least partially solid. After this distance of 8D, the thermoplastic polymer is in the molten state.

The outlet orifice 30 is arranged in a zone of the extrusion screw 7 in which the thermoplastic polymer is at least partially solid, i.e. not yet fully molten, so as to limit the constraints linked to the pressure of the composition. The liquid is thus injected where the thermoplastic polymer is either in the solid state, in the form of granules, or in the partially solid state.

The different positions of the outlet orifices 30 mentioned above can further be combined by providing a plurality of outlet orifices 30.

According to a preferred embodiment, the injection channel 22 comprises a plurality of outlet orifices 30 distributed around the extrusion screw 7. A single injection channel 22 thus makes it possible to inject a liquid at a plurality of injection points so as to obtain improved diffusion of the liquid. The outlet orifices 30 can emerge in different positions along the longitudinal axis A.

In order to allow injection in the same longitudinal position, the outlet orifices 30 are preferably positioned in the same plane perpendicular to the longitudinal axis A. It is thus possible to inject the liquid all around the extrusion screw 7 or at the very least at a plurality of injection points in order to obtain improved distribution of the liquid in the composition. The injection points are for example spaced a distance of 1 D apart along the longitudinal axis A.

In order to make it easier to manufacture the injection channel 22, the injection channel 22 extends in a rectilinear direction between the inner 23 and outer 27 surfaces of the barrel 6. It is thus possible to produce the injection channel 22 by a single bore extending between the inner 23 and outer 27 surfaces. Preferably, the injection channel 22 extends perpendicular to the longitudinal axis A, i.e. radially relative to this longitudinal axis A.

FIG. 4 shows a cross-sectional view transverse to the longitudinal axis A showing two injection channels 22 emerging on an upper portion of the barrel 6. Each injection channel 22 is connected to a liquid feed duct 46 communicating with a liquid feed member.

The extrusion screw 7 can also comprise a cooling channel 44 extending inside the elongated body 24. A cooling liquid, for example water, can be circulated inside this cooling channel. This cooling liquid is not intended to be injected so that it comes into contact with the thermoplastic polymer. This cooling channel 44 is thus a closed loop inside the extrusion screw 7. In other words, the cooling channel 44 does not comprise any orifices emerging inside the barrel 6.

The invention also provides a method for manufacturing an electric cable comprising at least one elongated electrically conductive element and at least one extruded thermoplastic layer surrounding said elongated electrically conductive element. This thermoplastic layer is extruded using an extruder 5 as described above.

During a first step i), a composition comprising at least one thermoplastic polymer in solid form is introduced into a zone of the extrusion screw referred to as the feed zone and situated at the inlet of the extruder.

In a second step ii), the composition resulting from step i) is conveyed from the feed zone to one or more intermediate zones of the extrusion screw 7, making it possible for the composition to be transported to the extrusion head 8 and for the thermoplastic polymer to melt gradually.

A third step iii) consists of applying the composition resulting from step ii) around the elongated electrically conductive element at the extruder head 8.

During the method, at least one liquid is injected between the barrel 6 and the extrusion screw 7 through the injection channel 22.

1. An extruder for extruding an electric cable comprising at least one elongated electrically conductive element and at least one extruded thermoplastic layer surrounding said elongated electrically conductive element, said extruder comprising:
a member for feeding a polymer in solid form,
a barrel fed by the feed member,
an extrusion screw arranged inside the barrel and making it possible for the polymer to melt gradually to form an extrusion composition and for this composition to be transported along the extrusion screw to a distal end of the extrusion screw, said extrusion screw extending along a longitudinal axis, said extrusion screw comprising a barrier zone having at least two threads,
an extrusion head arranged at a distal end of the extrusion screw and configured to apply the composition around an elongated electrically conductive element,
wherein at least one channel for injecting a liquid is formed through the barrel, said at least one injection channel comprising at least one outlet orifice emerging in a zone of the extrusion screw in which the thermoplastic polymer is at least partially in the solid state.

2. The extruder according to claim 1, wherein said at least one outlet orifice emerges upstream of the barrier zone, between the feed member and the barrier zone.

3. The extruder according to claim 1, wherein the barrier zone of the extrusion screw starts at a distance separating the barrier zone from the feed member, projected on the longitudinal axis, greater than or equal to 8D.

4. The extruder according to claim 3, wherein the distance separating the barrier zone from the feed member, projected on the longitudinal axis, is defined as being between 8D and 12D.

5. The extruder according to claim 1, wherein the distance separating said at least one outlet orifice from the feed member, projected on the longitudinal axis, is less than or equal to 8D, D being the nominal diameter of the extrusion screw.

6. The extruder according to claim 1, wherein the distance separating said at least one outlet orifice from the feed member, projected on the longitudinal axis, is greater than or equal to 2D, D being the nominal diameter of the extrusion screw.

7. The extruder according to claim 6, wherein the distance separating said at least one outlet orifice from the feed member is greater than or equal to 3D.

8. The extruder according to claim 7, wherein the distance separating said at least one outlet orifice from the feed member is greater than or equal to 4D.

9. The extruder according to claim 1, wherein said at least one injection channel comprises at least one inlet orifice formed on an outer surface of the barrel, said at least one outlet orifice emerging on an inner surface of the barrel, said at least one injection channel extending through the barrel between said at least one inlet orifice and said at least one outlet orifice.

10. The extruder according to claim 1, wherein said at least one injection channel extends perpendicular to the longitudinal axis.

11. The extruder according to claim 1, comprising a plurality of injection channels formed through the barrel and distributed about the longitudinal axis.

12. The extruder according to claim 11, wherein the injection channels are positioned in at least one plane perpendicular to the longitudinal axis.

13. The extruder according to claim 1, further comprising a liquid feed member communicating with said at least one injection channel.

14. A method for manufacturing an electric cable comprising at least one elongated electrically conductive element and at least one extruded thermoplastic layer surrounding said elongated electrically conductive element, said method implementing an extruder according to claim 1, wherein said method comprises at least the following steps:
i) a step of introducing a composition comprising at least one thermoplastic polymer in solid form into a zone of the extrusion screw referred to as the feed zone and situated at the inlet of the extruder,
ii) a step during which the composition resulting from step i) is conveyed from the feed zone to one or more intermediate zones of the extrusion screw, making it possible for the composition to be transported to the extrusion head situated at the outlet of the extruder and for the thermoplastic polymer to melt gradually,
iii) a step of applying the composition resulting from step ii) around the elongated electrically conductive element at the head of the extruder,
wherein at least one liquid is injected between the barrel and the extrusion screw through said at least one injection channel formed through the barrel, in a zone of the extrusion screw in which the thermoplastic polymer is in the at least partially solid state.

15. The method according to claim 14, wherein said at least one thermoplastic polymer in solid form is selected from a propylene homopolymer and a propylene copolymer, the liquid being a dielectric liquid.
